(19) United States
(12) Patent Application Publication
(10) Pub. No.: US 2002/0137470 A1
(43) Pub. Date: Sep. 26, 2002

(54) Method and system for multiple stage dialing using voice recognition

(76) Inventors: Jason C. Baron, San Diego, CA (US); Robert Opalsky, San Diego, CA (US)

Correspondence Address: Qualcomm Incorporated, Patents Department, 5775 Morehouse Drive, San Diego, CA, 92121-1714, US

(21) Appl. No.: 09/815,523

(22) Filed: Mar. 23, 2001

(51) Int. Cl. H04B 1/46

(52) U.S. Cl. 455/79; 455/67.7; 455/564

(57) ABSTRACT

A method for multiple stage dialing using voice recognition (VR) includes the steps of receiving a first voice command that designates an entry in an address book; dialing a first portion of a dialing stream until a pause code is detected; receiving a second voice command; and dialing a second portion of the dialing stream in response to the second voice command. The first and second portions of the dialing stream may include a long distance carrier address and an access code, respectively. The third voice command may correspond to an entry name field of the further address book entry.

### BACKGROUND OF THE INVENTION

I. Field of the Invention

The present invention relates generally to wireless communications devices. More specifically, the present invention relates to a method and system for multiple stage dialing using voice recognition.

II. Description of the Related Art

Communications devices, such as wireless telephones, personal digital assistants (PDAs), and personal computers, typically contain programmable address books. These address books enable users to conveniently store network addresses. Often, these communications devices can automatically access stored network addresses from such address books to establish connections with other communications devices. Such automatic access enables the initiation of communications with little user involvement.

The establishment of certain connections requires symbol sequences to be sent across a communications network in multiple stages. The placement of a long distance telephone call with a calling card is an example of a connection establishment procedure that requires multiple stages. To establish a calling card call, it is typically necessary to dial a long distance carrier number followed by an access code and then the phone number of the called party. The access code cannot be dialed until the long distance carrier indicates that it is ready for access code dialing. Similarly, the phone number typically cannot be dialed until the long distance carrier indicates that it has authorized the call.

Existing communications devices, such as cellular or satellite phones, contain address books that store names and numbers which can be automatically dialed by selecting the desired entry in the address book. Many such devices allow for multiple stage dialing. This is done by sequentially selecting multiple entries in the address book and then activating each selected entry in turn. Some type of user interaction is required to access the desired address book entry and then select it for dialing. Typically, the user is required to press one or more keys on a telephone keypad to access and select each desired address book entry. In many situations, this type of manual interaction can be inconvenient or dangerous. For example, it is both inconvenient and dangerous for a vehicle driver to be required to press multiple keys on the phone when driving. It would be highly desirable for a vehicle driver to be able to access multiple stage dialing features without taking his or her eyes off the road and disrupting their driving concentration.

Current speech processing technology enables information to be converted from text to speech and vice versa. There are currently available speech activated telephones. These can be found mostly in high end cellular phones for automobiles. With such phones, the driver can say aloud “Call Home”. The phone's voice processor will convert that statement to electronic signals that can be matched against entries stored in the phone's address book. If a match for “Home” is found, the phone will automatically dial the number associated with that name.

To date, speech activated phones have only been available to dial a single number sequence associated with a single stored entry. Known speech activated phones do not permit multi-stage dialing. Thus, if a driver wants to place a long distance call using a specific long distance service requiring an access code and/or entry of a credit card number, for example, the driver will still have to place the call manually by depressing the appropriate digits on the telephone keypad. What is needed, therefore, is some means for providing voice activated multi-stage dialing.

### SUMMARY OF THE INVENTION

The present invention is directed to a system, method, and computer program product for multiple stage dialing using voice recognition (VR). The present invention includes a method and system for receiving a first voice command that designates an entry in an address book; dialing a first portion of a dialing stream until a pause code is detected; receiving a second voice command; and dialing a second portion of the dialing stream in response to the second voice command.

In addition, the method and system may also include detecting a further pause code after the second portion of the dialing stream is dialed; receiving a third voice command that designates a further entry in the address book; and dialing a further dialing stream associated with the further entry in response to the third voice command.

The first and second portions of the dialing stream may include a long distance carrier address and an access code, respectively. The third voice command may correspond to an entry name field of the further address book entry.

The present invention advantageously enables multiple stage address book dialing with minimal user involvement. As a result, multiple stage dialing does not monopolize a user's attention. Furthermore, the present invention advantageously provides ease of use through voice commands. In addition, the present invention controls RF transmissions in wireless communications devices to prevent unintended transmissions.

### BRIEF DESCRIPTION OF THE DRAWINGS

The present invention will be described with reference to the accompanying drawings. In the drawings, like reference numbers generally indicate identical, functionally similar, and/or structurally similar elements. The drawing in which an element first appears is indicated by the leftmost digit(s) in the reference number.

FIG. 1 is an illustration of an exemplary communications environment;

FIG. 2 is a block diagram of a wireless communications network interface device;

FIG. 3 is a block diagram of software of a wireless communications device;

FIG. 4 is an illustration of an exemplary address book entry;

FIG. 5 is a diagram of an automatic dial state machine of a wireless communications device;

FIG. 6 is a flowchart illustrating a sequence of operations of a wireless communications device; and

FIG. 7 is a block diagram of an exemplary computer system.

### DETAILED DESCRIPTION OF THE PREFERRED EMBODIMENTS

I. Introduction

Voice recognition (VR) technology enables information to be converted from speech signals into commands that drive the performance of electronic devices. This technology permits the development of user interfaces that are easy to operate. In addition, since these interfaces are easy to operate, they enable a user to perform other tasks with minimal distraction. The present invention leverages VR technology to provide automatic multiple stage dialing of telephone numbers.

II. Communications Environment

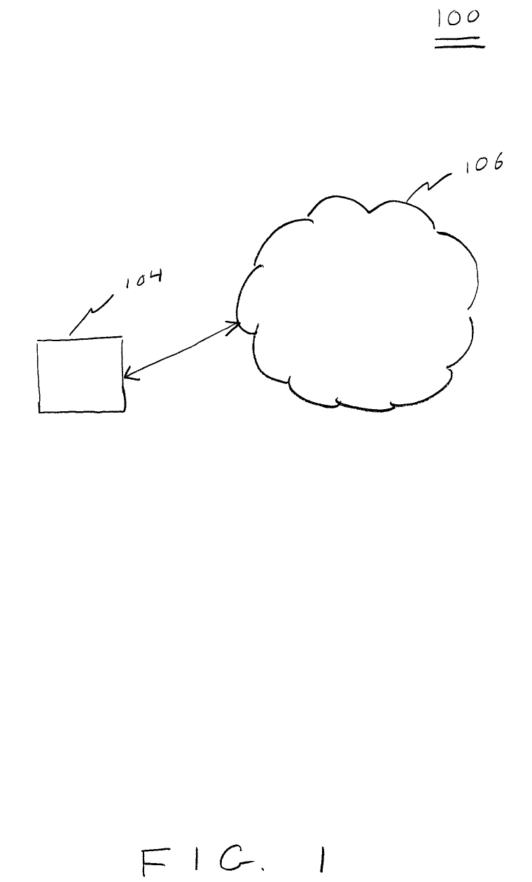

FIG. 1 is a block diagram of an exemplary communications environment 100. Communications environment 100 includes a communications device 104, and a communications network 106. Communications device 104 exchanges information, such as voice and data signals, with communications network 106. In addition, communications device 104 can establish connections (or sessions) with other communications devices (not shown) that also exchange information with communications network 106.

Communications device 104 is a wireless communications device (WCD), such as a cellular phone or a satellite phone. However, communications device 104 may be any device that exchanges information with a communications network such as a wired telephone in a personal computer, a pager, a personal digital assistant (PDA), or a wireless personal computer.

Communications network 106 is a wireless communication network, such as a mobile cellular telephone system employing CDMA. An example of such a network is described in U.S. Pat. No. 5,103,459 entitled “System and Method for Generating Signal Waveforms in the CDMA Cellular Telephone System” issued Apr. 17, 1992 to the assignee of the present invention. The '459 patent is incorporated herein by reference in its entirety. However, communications network 106 may also be a satellite communications network, or a conventional telecommunications network.

WCD 104 establishes connections with other communications devices through the exchange of radio frequency (RF) signals with wireless communications network 106. This exchange of RF signals involves the transmission and reception of signals with a base station (not shown) or a satellite (not shown) within wireless communications network 106.

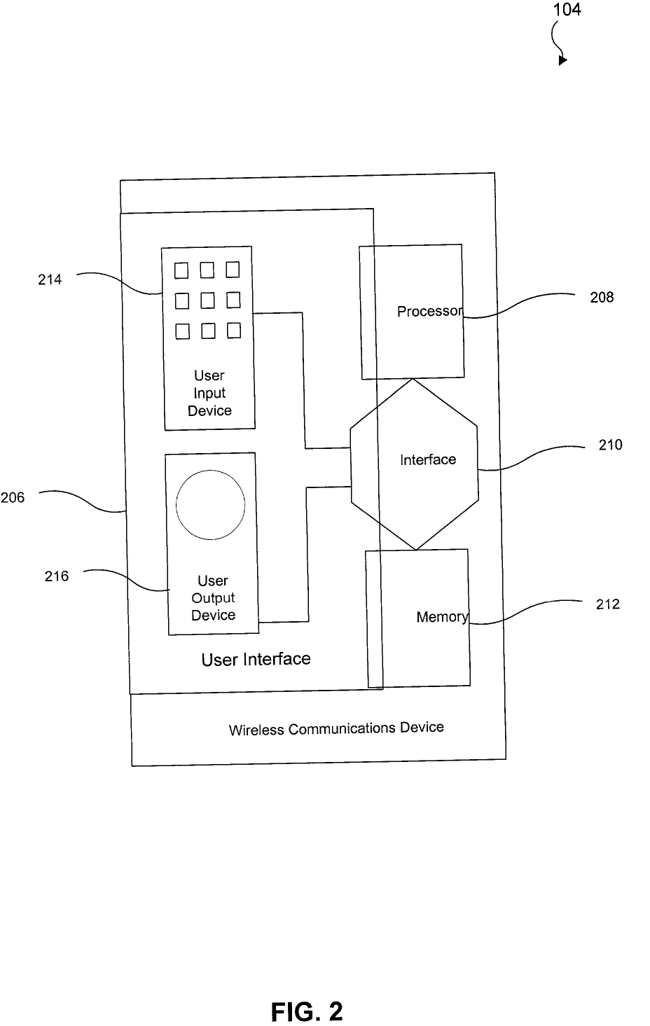

FIG. 2 is a functional block diagram of WCD 104. WCD 104 includes a user interface 206, a processor 208, an interface 210, and a memory 212. User interface 206 includes a user input device 214 and a user output device 216. User input device 214 is coupled to interface 210 for connectivity with processor 208 and memory 212. Interface 210 is coupled to memory 212 and processor 208. User input device 214 and user output device 216 are within user interface 206. User interface 206 also includes one or more software components that reside in memory 212 and are processed by processor 208.

User input device 214 includes device(s) that can accept user input. For example, user input device 214 may be a keypad on a wireless telephone, a keyboard on a personal computer, or a touch screen. User input device 214 also includes a microphone to receive voice signals. User input device 214 converts these voice signals into analog voltage signals, and encodes these analog signals into a digital information stream.

User output device 216 includes a display that enables WCD 104 to output information to a user. This display can include light emitting diodes (LEDs), liquid crystal displays (LCDs), video displays, and/or other display devices known to persons skilled in the relevant arts. User output device 216 also includes a speaker that enables a user to listen to audio and telephonic voice signals received from communications network 106.

Processor 208 includes one or more processing components that have the capability to process computer software in the form of lines of executable code. These lines of executable code reside in memory 212 and include commands written in one or more computer programming languages, such as C, C++, JAVA, and assembly language. Processor 208 may distribute processing capability among one or more application specific integrated circuits (ASICs), such as Mobile Station Modem™ (MSM™) chips. MSM™ chips are designed for use in wireless communications applications and incorporate code division multiple access (CDMA) functionality. Exemplary processors 208 also include the Advanced RISC Machines (ARM®) microprocessor and personal computer processors, such as microprocessors manufactured by the Intel Corporation of Santa Clara, Calif.

Interface 210 allows a functional coupling of components within WCD 104. Interface 210 may be implemented with a computer system bus that allows the transmission of electrical signals between components of WCD 104.

Memory 212 is any storage medium capable of storing information. Memory 212 may include one or more storage components, such as random access memory (RAM), flash memory, and read only memory (ROM). Memory 212 may also include removable memory such as a floppy disk, or any other memory that can be used to store computer software and/or information processed by processor 208.

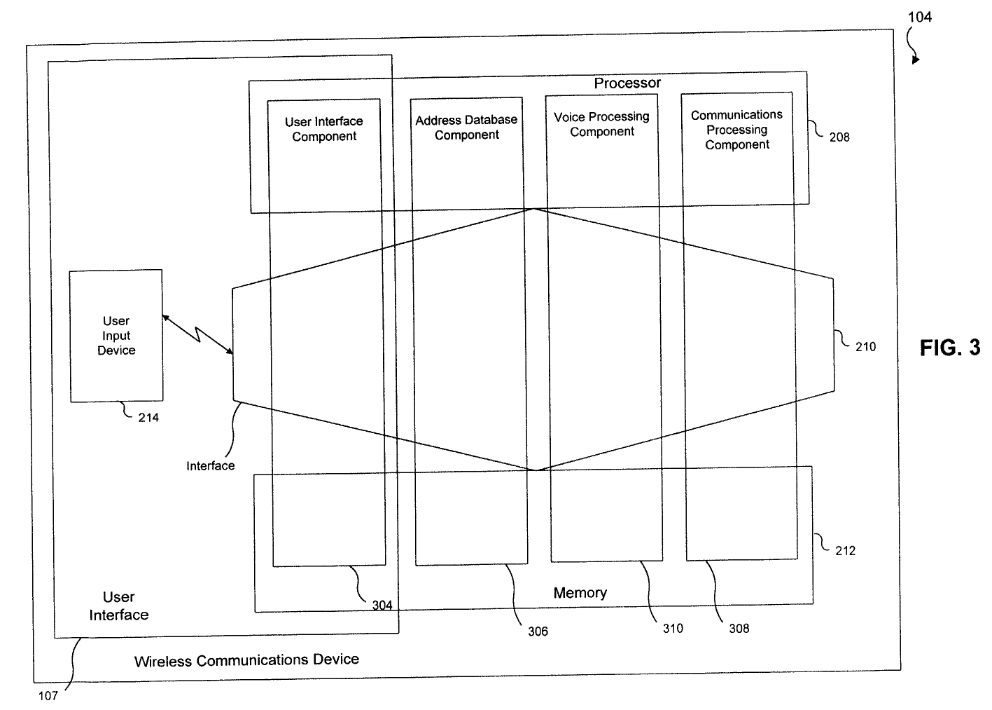

FIG. 3 is a block diagram illustrating various software components of wireless telephone 104. As described herein, memory 212 stores computer software processed by processor 208 to perform specific functions. This computer software is arranged into a plurality of software components. These software components include a user interface component 304, an address database component 306, a communications processing component 308, and a voice processing component 310.

Each of these software components includes one or more software modules. A software module is a portion of computer program code that performs a set of specified functions. Examples of software modules include subroutines, functions, objects, programs, and sub-programs.

User interface component 304 receives, processes, and stores information in memory 212 that is entered by a user through user input device 214. In addition, user interface software 304 receives information from other components of WCD 104. This received information is processed and sent to user output device 216.

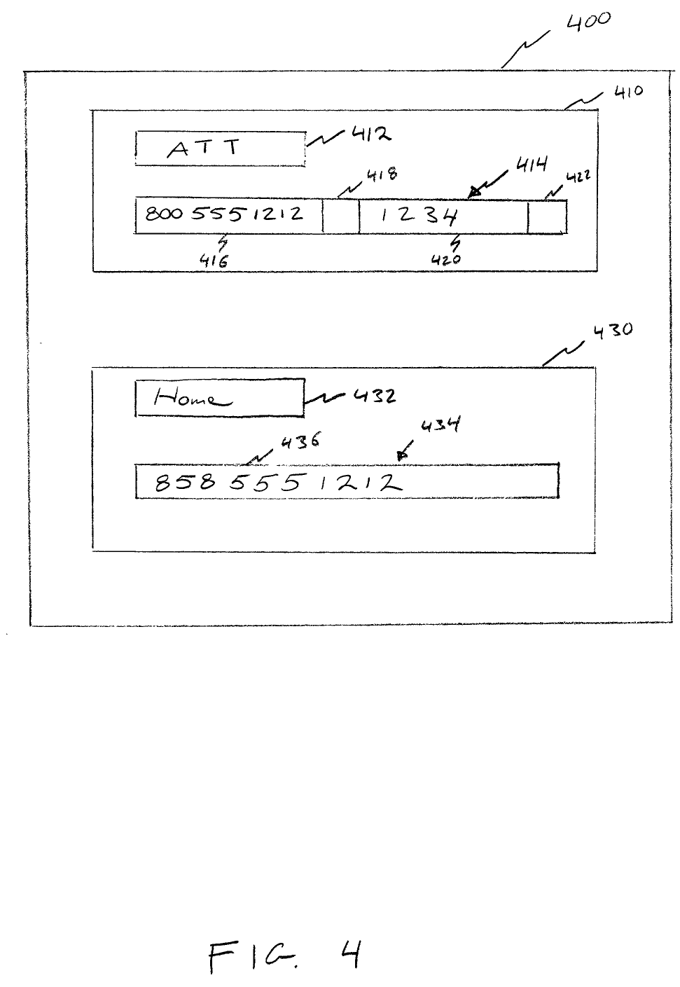

Address database component 306 provides for the storage and retrieval of address book entries. Address database component 306 stores such entries in memory 212. As described below with reference to FIG. 4, address book entries may contain network addresses that enable WCD 104 to automatically establish connections with other communications devices through communications network 106.

Communications processing component 308 performs call processing functions. For example, communications processing component 308 establishes connections with one or more other communications devices through communications network 106. These connections are established by transmitting signaling messages that include symbols, such as dial tones, across communications network 106. These signaling messages contain network addresses, such as telephone numbers, to identify other communications devices. Communications processing component 308 receives these network addresses from other components of WCD 104. For instance, communications processing component 308 may receive network addresses from user input device 214 that are manually entered by a user. Alternatively, communications processing component 308 may receive network addresses from address database 306.

Voice processing component 310 provides for the processing of voice signals. Namely, voice processing component 310 performs speech-to-text conversion of voice signals received from users through user input device 214. Voice processing component 310 performs such conversion using known speech processing algorithms.

III. Multiple Stage Dialing

FIG. 4 is an illustration of an address book 400 containing two address book entries 410 and 430. Address book 400 is stored in memory 212. Each of these entries includes fields separated by pause codes to enable the dialing of these fields in multiple stages.

Address book entry 410 is associated with a long distance provider. Address book entry 410 includes an entry name field 412, and a dialing stream 414. Dialing stream 414 includes a long distance carrier field 416, a first pause code 418, an access code field 420, and a second pause code 422. Address book entry 430 is associated with another communications device, such as another WCD 104. Address book entry 430 includes an entry name field 432 and a dialing stream 434, which has telephone number field 436.

Entry name field 412 contains a text string that identifies a long distance carrier by its name. Entry name field 412 can be matched to user speech by voice processing component 310. Within symbol sequence 414, long distance carrier field 416, access code field 420, and telephone number field 436 each contain a distinct sequence of symbols, such as a numbers. However, these fields may contain other types of symbols, such as alphabetic characters.

Pause codes 418 and 422 provide an indication to WCD 104 that automatic dialing activity needs to be suspended after the symbol sequence contained in a preceding field has been dialed. For example, pause code 418 indicates that WCD 104 needs to suspend dialing after long distance carrier field 416 has been dialed. Similarly, pause code 422 indicates that WCD 104 needs to suspend automatic dialing activity after the symbol sequence in access code field 420 has been dialed.

Pause codes 418 and 422 also provide an indication to WCD 104 that certain event(s) need to occur before automatic dialing operations can continue. Thus, pause code 418 establishes condition(s) that must occur before WCD 104 proceeds to automatically dial access code field 420. Likewise, pause code 422 provides conditions that must occur before WCD 104 commences the automatic dialing of symbol sequences contained in field(s) of another address book entry, such as entry 430.

Entry name field 432 contains a text string that corresponds to telephone number field 436. For example, entry name field 432 may contain a person's name, or business name. Entry name field 432 can be matched to user speech by voice processing component 310. Telephone number field 436 contains a telephone number.

The pause codes described above may be one of many different pause code types. Each pause code type requires a different condition to be satisfied before an automatic dialing operation continues. Hard pauses, timed pause codes, VR hard pause codes, and VR dial pause codes are four exemplary pause code types. With reference to FIG. 4, pause code 418 is a VR hard pause, pause code 422 is a VR dial pause code.

Hard pause codes require user intervention before automatic dialing operations can resume. The pressing of one or more keys on user input device 214 is an example of such user intervention.

Unlike hard pause codes, timed pause codes require no user intervention for automatic dialing operations to continue. Instead, a timed pause code requires the expiration of a timer (e.g., a two second timer) to occur before an automatic dialing operation can resume.

Similar to hard pause codes, VR hard pause codes require a user to utter a spoken command, such as “go” or “proceed,” before an automatic dialing operation can continue.

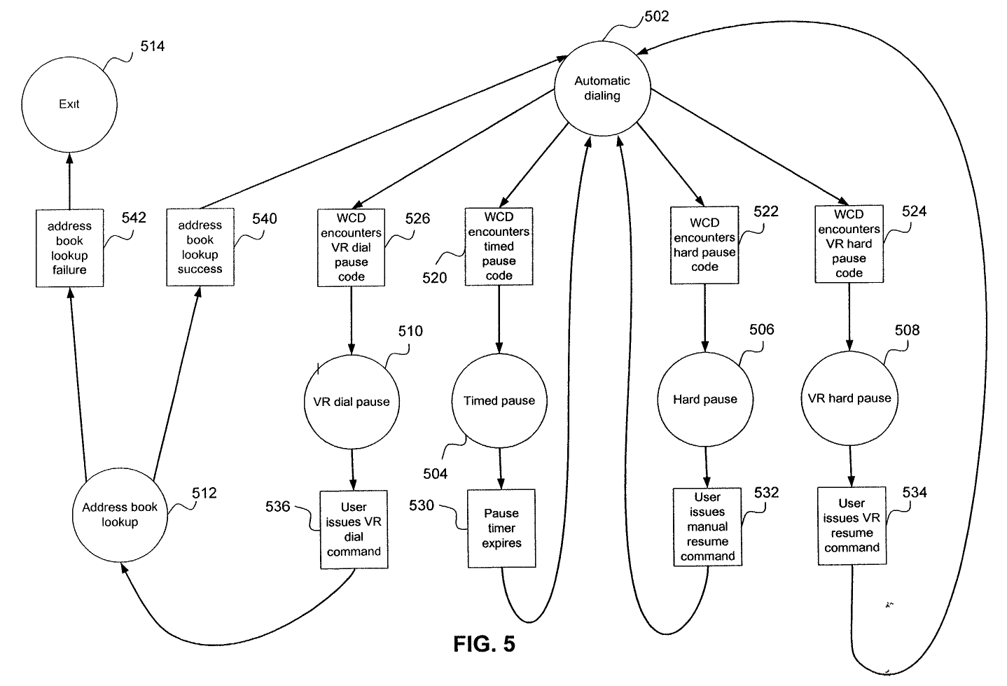

FIG. 5 is a diagram of an automatic dial state machine of a wireless communications device. This diagram illustrates transitions between various operational states of WCD 104. The operational states are shown in FIG. 5 as circles. Transitions between these states are shown as connections between circles. Each of these connections includes a rectangular box containing text that describes the respective transition causing event. Transition causing events are typically based on user interaction with WCD 104.

As shown in FIG. 5, WCD 104 can exist in an automatic dialing state 502, a timed pause state 504, a hard pause state 506, a VR hard pause state 508, a VR dial pause state 510, an address book lookup state 512, and an exit state 514. These states and certain transitions between them are described below. These particular states and transitions are presented by way of example only. Other operational states, transitions, and transition causing events may be employed, as would be apparent to a person skilled in the relevant arts.

During automatic dialing state 502, WCD 104 is in the process of “dialing” a symbol sequence, such as a sequence of dial tones across a telecommunications network. During this state, WCD 104 dials a sequence contained in an address book field.

Transitions from dialing state 502 to timed pause state 504, hard pause state 506, VR hard pause state 508, and VR dial pause state 510 occur when a pause code has been encountered during the dialing of an address book entry. In these pause states, WCD 104 suspends dialing activity, and will not dial further fields of an address book entry, until the occurrence of a transition causing event that either returns WCD 104 to dialing state 502 or places WCD 104 in address book lookup state 512. As shown in FIG. 5, the events that cause transitions from dialing state 502 to these pause states are events 520, 522, 524, and 526.

Transition causing event 520 causes WCD 104 operation to proceed from dialing state 502 to timed pause state 504. This event occurs when a timed pause code is encountered during an automatic dialing operation. When WCD 104 is in timed pause state 504, it is waiting for a pause timer to expire before returning WCD 104 to dialing state 502. The expiration of this timer is shown in FIG. 5 as a transition causing event 530.

Transition causing event 522 causes WCD 104 operation to proceed from dialing state 502 to hard pause state 506. This event occurs when a hard pause code is encountered during an automatic dialing operation. WCD 104 remains in hard pause state 506 until transition causing event 532 occurs. Upon occurrence of an event 532, WCD 104 operation returns to dialing state 502. Transition causing event 532 is a manual input from a user, such as a designated keypad entry.

Transition causing event 524 occurs when a VR hard pause code is encountered during an automatic dialing operation. This event causes WCD 104 operation to proceed from dialing state 502 to VR hard pause state 508. WCD 104 will remain in VR hard pause state 508 until a transition causing event 534 occurs. Transition causing event 534 is the issuance of a spoken resume command by a user. The words “resume,” “proceed,” “continue,” and “go” are examples of spoken resume commands. Once transition causing event 534 occurs, WCD 104 returns to automatic dialing state 502.

Transition causing event 526 causes WCD 104 operation to proceed from dialing state 502 to VR dial pause state 510. This event occurs when a VR dial pause code is encountered during an automatic dialing operation. WCD 104 remains in VR dial pause state 510 until a transition causing event 536 occurs. When this event occurs, WCD 104 operation proceeds to address book lookup state 512. Transition causing event 532 is a spoken dial command from a user. The uttering of an address entry name, such as entry name 432, is an example of a spoken dial command.

In address book lookup state 512, WCD 104 accesses an entry in address book 400, such as entry 430. This access is performed by matching a spoken dial command uttered by a user with an entry name in address book 400. If a matching entry name exists, then a corresponding dialing stream is retrieved from address book 400.

The existence of a match indicates a successful address book lookup operation, which is represented in FIG. 5 as a transition causing event 540. The occurrence of this event causes WCD 104 to return to automatic dialing state 502. Upon returning to automatic dialing state 502, WCD 104 commences automatic dialing of the dialing stream retrieved in state 512.

If WCD 104 fails to find a matching entry name while operating in address book lookup state 512, then a transition causing event 542 has occurred. This event causes WCD 104 operation to transition to exit state 514. A failure to find a matching entry name occurs after one or more matching attempts. After a first attempt, each successive attempt may include WCD 104 outputting a request for a user to repeat the spoken dial command that was uttered before WCD 104 entered address book lookup state 512.

When WCD 104 is operating in exit state 514, automatic dialing operations have ended. As shown in FIG. 5, exit state 514 is entered from address book lookup state upon the occurrence of event 542. Although automatic dialing operations have ended, a user may manually dial a symbol sequence in exit state 514 to complete the establishment of connection.

As described above, when WCD 104 is in either VR hard pause state 508 or VR dial pause state 510, it awaits a spoken command by a user. These commands are for internal processing by WCD 104, and not for transmission across communications network 106. To prevent the transmission of unintended RF signals, WCD 104 disables RF transmission circuitry while it is in these states.

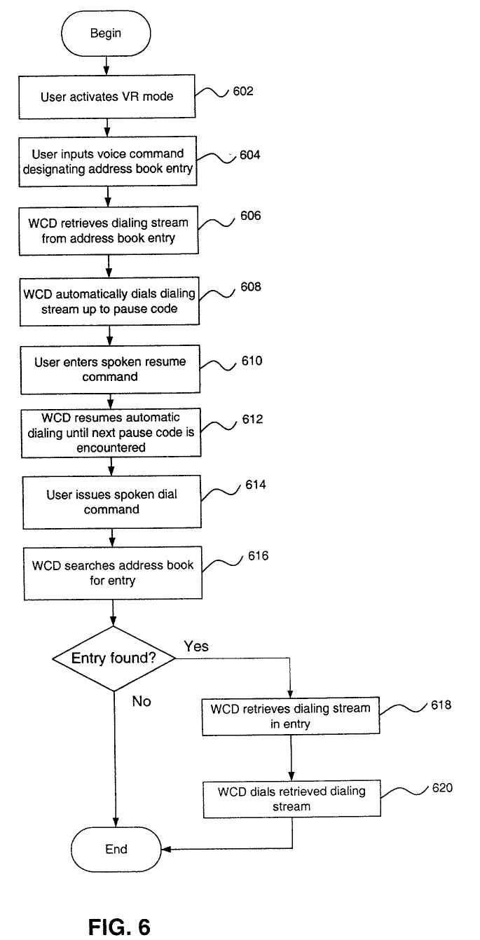

FIG. 6 is a flowchart illustrating a sequence of operation of WCD 104. This operational sequence involves the automatic dialing of dialing streams contained in address book entries 410 and 430. This sequence is described with reference to the operational states and transition causing events shown in FIG. 5.

Operation begins with a step 602, where a user activates a VR mode. This step comprises a user pressing a VR activation key on user input device 214. VR mode may also be activated by voicing a predetermined activation command.

In a step 604, a user inputs a voice command that designates entry 410 in address book 400. This step comprises a user uttering entry name 412 to designate entry 410. For example, the user may state “Call ATT” to initiate a call to AT&T long distance carrier service.

Next, in a step 606, WCD 104 retrieves dialing stream 414 from address book entry 410. Following step 606, in a step 608, WCD 104 automatically dials dialing stream 414 from its beginning up to VR pause code 418. That is, WCD 104 automatically dials long distance carrier field 416. During step 608, WCD 104 transitions from automatic dialing state 502 to VR hard pause state 508.

After step 608, a step 610 is performed. In step 610, a user enters a spoken resume command. Thus, in step 610, transition causing event 534 occurs. This step is not performed until a user receives an indication, such as an audible tone, that the long distance carrier dialed in step 608 is ready for dialing activity to continue.

Next, in step 612, dialing of dialing stream 414 resumes until VR dial pause code 422 is encountered. Thus, in this step, WCD 104 automatically dials access code field 420. During this dialing, WCD 104 is in automatic dialing state. However, once VR dial code 418 is encountered, WCD 104 transitions to VR dial pause state 510.

After step 612, a step 614 is performed. In this step, a user issues a spoken dial command. Thus, in step 614, transition causing event 536 occurs. This step comprises a user uttering the contents of entry name field 432. For example, the user may state “Call home.”

A step 616 follows the performance of step 614. In step 616, WCD 104 searches address book 400 for an entry name (e.g., “Home”) that matches the command uttered in step 614. If a match occurs, then a step 618 is performed. If a match does not occur, then the operation ends (i.e., transitions to exit state 514).

In step 618, WCD 104 retrieves a dialing stream corresponding to the matching entry name. In this case, WCD 104 retrieves dialing stream 434. A step 620 is performed next. In step 620, WCD 104 enters operational state 502 and automatically dials dialing stream 434.

The operation described above with reference to FIG. 6 involves the placement of a long distance calling card call. However, this operation may be applied to the initiation of connections and the access of information in other types of calls. For example, the techniques described above may be used to provide automatic multiple stage dialing strategies that allow users to access and retrieve information from a voice mailbox.

IV. Implementation

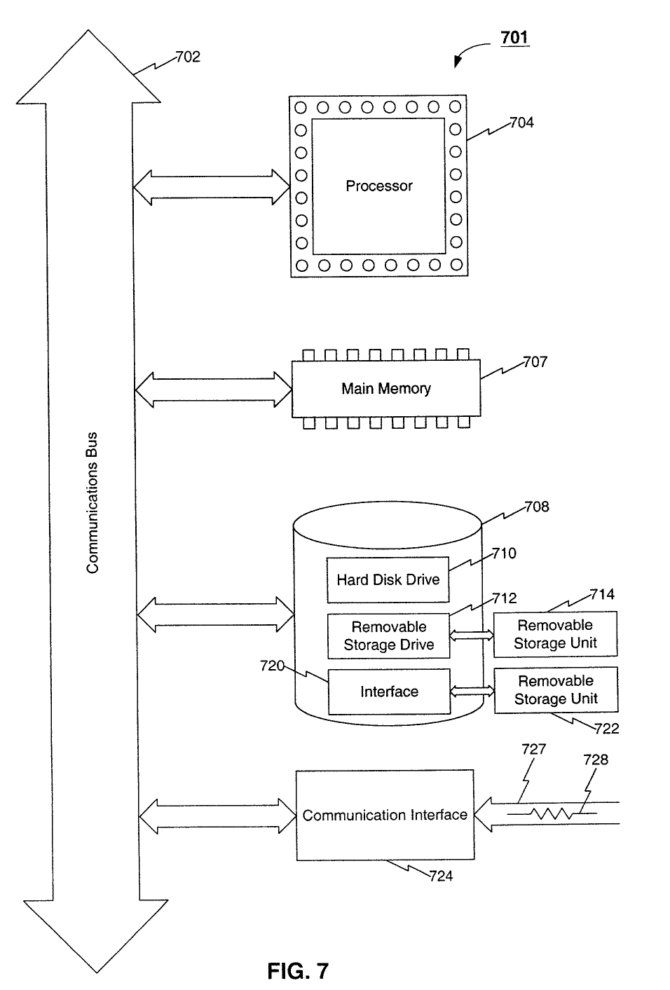

The functionality described herein may be implemented using hardware, software or a combination thereof and may be implemented in a computer system or other processing system. In fact, in one embodiment, the invention is directed toward a computer system capable of carrying out the functionality described herein. An exemplary computer system 701 is shown in FIG. 7. Computer system 701 includes one or more processors, such as a processor 704. The processor 704 is connected to a communication bus 702. Various software embodiments are described in terms of this example computer system. After reading this description, it will become apparent to persons skilled in the relevant art how to implement the invention using other computer systems and/or computer architectures.

Computer system 702 also includes a main memory 706, preferably random access memory (RAM), and can also include a secondary memory 708. The secondary memory 708 can include, for example, a hard disk drive 710 and/or a removable storage drive 712, representing a floppy disk drive, a magnetic tape drive, an optical disk drive, etc. The removable storage drive 712 reads from and/or writes to a removable storage unit 714 in a well known manner. Removable storage unit 714, represents a floppy disk, magnetic tape, optical disk, etc. which is read by and written to by removable storage drive 712. As will be appreciated, the removable storage unit 714 includes a computer usable storage medium having stored therein computer software and/or data.

In alternative embodiments, secondary memory 708 may include other similar means for allowing computer programs or other instructions to be loaded into computer system 701. Such means can include, for example, a removable storage unit 722 and an interface 720. Examples of such can include a program cartridge and cartridge interface (such as that found in video game devices), a removable memory chip (such as an EPROM, or PROM) and associated socket, and other removable storage units 722 and interfaces 720 which allow software and data to be transferred from the removable storage unit 722 to computer system 701.

Computer system 701 can also include a communications interface 724. Communications interface 724 allows software and data to be transferred between computer system 701 and external devices. Examples of communications interface 724 can include a modem, a network interface (such as an Ethernet card), a communications port, a PCMCIA slot and card, etc. Software and data transferred via communications interface 724 are in the form of signals which can be electronic, electromagnetic, optical or other signals capable of being received by communications interface 724. These signals 726 are provided to communications interface via a channel 728. This channel 728 carries signals 726 and can be implemented using wire or cable, fiber optics, a phone line, a cellular phone link, an RF link and other communications channels.

In this document, the terms “computer program medium” and “computer usable medium” are used to generally refer to media such as removable storage device 712, a hard disk installed in hard disk drive 710, and signals 726. These computer program products are means for providing software to computer system 701.

Computer programs (also called computer control logic) are stored in main memory and/or secondary memory 708. Computer programs can also be received via communications interface 724. Such computer programs, when executed, enable the computer system 701 to perform the features of the present invention as discussed herein. In particular, the computer programs, when executed, enable the processor 704 to perform the features of the present invention. Accordingly, such computer programs represent controllers of the computer system 701.

In an embodiment where the invention is implemented using software, the software may be stored in a computer program product and loaded into computer system 701 using removable storage drive 712, hard drive 710 or communications interface 724. The control logic (software), when executed by the processor 704, causes the processor 704 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software. Examples of such combinations include, but are not limited to, microcontrollers.

V. Conclusion

While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

1. A method of multiple stage dialing using voice recognition (VR), comprising the steps of:
(a) receiving a first voice command that designates an entry in an address book;
(b) dialing a first portion of a dialing stream until a pause code is detected;
(c) receiving a second voice command; and
(d) dialing a second portion of the dialing stream in response to said second voice command.

2. The method of claim 1, further comprising the step of receiving a VR mode activation command prior to step (a).

3. The method of claim 1, wherein the first portion of the dialing stream includes a long distance carrier address.

4. The method of claim 1, wherein the second portion of the dialing stream includes an access code.

5. The method of claim 1, further comprising the steps of:
(e) detecting a further pause code after performing step (d);
(f) receiving a third voice command that designates a further entry in the address book; and
(g) dialing a further dialing stream associated with the further entry in response to said third voice command.

6. The method of claim 5, wherein the third voice command corresponds to an entry name field of the further address book entry.

7. The method of claim 5, wherein step (f) comprises the step of matching the third voice command with the further address book entry.

8. The method of claim 5, wherein the further dialing stream includes a telephone number.

9. A system for multiple stage dialing using voice recognition (VR), comprising:
means for receiving a first voice command that designates an entry in an address book;
means for dialing a first portion of a dialing stream until a pause code is detected;
means for receiving a second voice command; and
means for dialing a second portion of the dialing stream in response to said second voice command.

10. The system of claim 9, further comprising means for receiving a VR mode activation command.

11. The system of claim 9, wherein the first portion of the dialing stream includes a long distance carrier address.

12. The system of claim 9, wherein the second portion of the dialing stream includes an access code.

13. The system of claim 9, further comprising:
means for detecting a further pause code;
means for receiving a third voice command that designates a further entry in the address book; and
means for dialing a further dialing stream associated with the further entry in response to said third voice command.

14. The system of claim 13, wherein the third voice command corresponds to an entry name field of the further address book entry.

15. The system of claim 13, wherein said means for receiving a third voice command comprises means for matching the third voice command with the further address book entry.

16. The system of claim 13, wherein the further dialing stream includes a telephone number.

17. A computer program product comprising computer program logic for enabling a processor in a computer system to perform multiple stage dialing using voice recognition (VR), said computer program logic comprising:
means for enabling the processor to receive a first voice command that designates an entry in an address book;
means for enabling the processor to dial a first portion of a dialing stream until a pause code is detected;
means for enabling the processor to receive a second voice command; and
means for enabling the processor to dial a second portion of the dialing stream in response to said second voice command.

18. The computer program product of claim 17, further comprising means for enabling the processor to receive a VR mode activation command.

19. The computer program product of claim 17, wherein the first portion of the dialing stream includes a long distance carrier address.

20. The computer program product of claim 17, wherein the second portion of the dialing stream includes an access code.

21. The computer program product of claim 17, further comprising:
means for enabling the processor to detect a further pause code;
means for enabling the processor to receive a third voice command that designates a further entry in the address book; and
means for enabling the processor to dial a further dialing stream associated with the further entry in response to said third voice command.

22. The computer program product of claim 21, wherein the third voice command corresponds to an entry name field of the further address book entry.

23. The computer program product of claim 21, wherein said means for enabling the processor to receive a third voice command comprises means for enabling the processor to match the third voice command with the further address book entry.

24. The system of claim 21, wherein the further dialing stream includes a telephone number.
